(19) United States
(12) Patent Application Publication
(10) Pub. No.: US 2004/0093842 A1
(43) Pub. Date: May 20, 2004

(54) Lawn mower blade device

(76) Inventor: Clifford L. Cooper, Dawsonville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/299,141

(22) Filed: Nov. 19, 2002

(51) Int. Cl. A01D 34/73

(52) U.S. Cl. 56/295

(57) ABSTRACT

A lawn mower blade device, wherein efficiency is increased through the incorporation of more than two replaceable cutting blades, thereby enabling cutting surface area to be enlarged without a resulting increase in mower housing dimensions, wherein cutting blade lifespan is increased through the effective distribution of rotational stress across a central hub, and wherein traditional metal blades provide strong, long-lasting service, eliminating the need for frequent part replacement.

### TECHNICAL FIELD

The present invention relates generally to lawn mowers and, more specifically, to a lawn mower blade device having at least three cutting blades, wherein increased cutting surface area produces a more efficient and refined cut, thereby enabling reduced bag-emptying frequency, decreased incidence of mower exit chute clogs, and extended mower lifespan by reducing engine strain and undesired speed variation.

### BACKGROUND OF THE INVENTION

Well tended landscaping increases the aesthetic appeal of all types of real estate. Both individually owned and commercial properties can realize an increase in asset value from such curb appeal. Therefore, maximizing one's real estate investment typically requires ongoing lawn maintenance and landscaping. Unfortunately, during the summer months when grass growth is rapid and/or in warm climate areas with year-round growth patterns, the repetitive weekly mowing schedule can become a lengthy, tedious and/or laborious chore.

In an effort to decrease mowing time by increasing the efficiency of lawn mowers, some designs have been proposed with dual cutting blades, wherein the blades are mounted side-by-side and rotate about separate but cooperative and/or counter-rotational axes. Although these designs essentially double the lawn surface area in contact with the mower blades at any given instant, they also necessitate a generally proportional increase in the size of the mower housing. For narrow grassy areas bordered by trees or other barricades, and for individuals with limited storage space for landscaping equipment, larger mower housings are disadvantageous.

Most lawn mowers utilize a single elongated blade with cutting surfaces defined on each opposing end, wherein rotary motion of the blade brings each of the cutting surfaces into contact with the grass to be cut. Efforts have been made to facilitate the cutting process by building larger engines and longer cutting blades to enable a larger circumference to be trimmed with each pass of the rotary mower blade. Unfortunately, however, such increases in blade length also necessitate a corresponding increase in mower housing.

Other lawn mower rotary cutters have been proposed in an effort to increase the number of available cutting surfaces without increasing overall mower housing dimensions. However, such designs are disadvantageous in view of the present invention. One-piece plastic composite multi-blades and units with flexible plastic pins and/or filament cutters are often subject to repeated breakage and increased damage from contact with stones, sticks and/or other lawn debris, wherein composite material failure and/or general blade wear can necessitate frequent replacement. Although integrally formed cross-shaped cutters increase available cutting surface, they are disadvantageous in view of the present invention due to the inherent increased rotational stress on the central support region, increasing incidence of failure of cutting arms, and further due to the inability to interchange arms and/or alter the number of arms available for cutting.

Therefore, it is readily apparent that there is a need for a lawn mower blade device, wherein efficiency is increased through the incorporation of more than two preferably replaceable cutting blades supported by a generally circular-shaped hub, whereby rotational stress is distributed over the generally circular central region to reduce incidence of failure of individual blades, and whereby cutting surface area is enlarged without a resulting increase in mower housing dimensions, permitting traditional metal blades to provide strong, long-lasting service, thus eliminating the need for frequent replacement thereof and avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a lawn mower blade device having at least three cutting blades, wherein increased cutting surface area produces a more efficient and refined cut, thereby reducing variations in engine speed during use in tall and/or thick grasses, and decreasing exit chute and grass-catcher clogs to enable a more continuous, productive and engine-friendly mowing experience.

According to its major aspects and broadly stated, the present invention is a lawn mower blade device, wherein efficiency is increased via the incorporation of more than two replaceable cutting blades, thereby enlarging cutting surface area without requiring an increase in overall mower housing dimensions, and wherein cutting blade lifespan is increased through the effective distribution of rotational stress across a central hub, allowing traditional metal blades to provide strong, long-lasting service, thus eliminating the need for frequent part replacement.

More specifically, the device of the present invention in its preferred form is a lawn mower blade having a generally circular-shaped hub adapted to be received on any conventional lawn mower, and having at least three cutting blades radially extending from the rotating hub. Accordingly, the preferred embodiment of the present invention enables at least three cutting edges to contact a given lawn surface area during each rotation of the hub, substantially increasing cutting blade surface area.

The generally circular-shaped hub has a centrally defined universal aperture surrounded by a plurality of generally elongated apertures, wherein mounting to any type of rotary mower is enabled via adaptor bushings or the like at the central universal aperture, and wherein the hub is secured via bolts passing through the elongated apertures. At least three cutting blades are secured to the hub in an arrangement wherein each cutting blade extends outwardly from the hub to enable the cutting surfaces thereof to contact the grass during rotation of the hub. The blades are secured via a plurality of locking bolts, wherein a plurality of recessed blade receiving areas may be defined in a surface of the hub. The preferred circular-shaped hub distributes the rotational forces received by the cutting blades, thereby reducing strain on the extended length portion of the cutting blades. Furthermore, the increased surface area provided by the circular-shaped hub enables the inclusion of multiple mounting aperture placement options.

A feature and advantage of the present invention is the ability of such a device to increase the effective cutting surface area of a lawn mower, thereby producing a more efficient and refined cut.

Another feature and advantage of the present invention is the ability of such a device to produce a cleaner, more refined grass clipping byproduct, thereby enabling more effective bag filling and reduced bag-emptying frequency.

Another feature and advantage of the present invention is the ability of such a device to produce a finer cut, thereby decreasing incidence of mower exit chute clogging.

Another feature and advantage of the present invention is the ability of such a device to reduce mower engine strain due to speed variation in response to deep and/or dense grasses, thereby extending mower lifespan.

Another feature and advantage of the present invention is the ability of such a device to enable a user to efficiently perform lawn maintenance chores.

Another feature and advantage of the present invention is the ability of such a device to provide a lawn mower with increased efficiency via an increased cutting surface.

Another feature and advantage of the present invention is the ability of such a device to provide a lawn mower with increased cutting surface area, wherein the lawn mower housing remains compact to enable use in narrow grassy areas.

Another feature and advantage of the present invention is the ability of such a device to provide a lawn mower with more than two blades, wherein the lawn mower housing remains compact to enable storage within limited space.

Another feature and advantage of the present invention is the ability of such a device to minimize the incidence of breakage of and/or damage to components from stones, sticks or other lawn debris.

Another feature and advantage of the present invention is the ability of such a device to enable individual blade removal and replacement.

Another feature and advantage of the present invention is the ability of such a device to be adapted to an existing lawn mower, thereby enabling an increase in efficient productivity without necessitating replacement of the mower and/or engine.

Another feature and advantage of the present invention is the ability of such a device to increase the number of exposed metal cutting surfaces without substantially deviating from the optimum rotary blade weight.

Another feature and advantage of the present invention is the ability of such a device to increase blade lifespan by distributing rotational forces across a circular-shaped hub.

Another feature and advantage of the present invention is the ability of such a device to increase the universality of adaptation to any type of mower by increasing the surface area available for various types of mounting aperture placements and dimensions.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top view of a lawn mower blade device according to a preferred embodiment of the present invention.

FIG. 2 is a bottom view of the lawn mower blade device of FIG. 1.

FIG. 3 is a bottom view of a lawn mower blade device according to an alternate embodiment of the present invention, showing a hub with no blades attached thereto.

FIG. 4 is a cross-sectional view of the lawn mower blade device of FIG. 3.

FIG. 5 is a bottom view of a lawn mower blade device according to another alternate embodiment of the present invention, showing a hub with no blades attached thereto.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

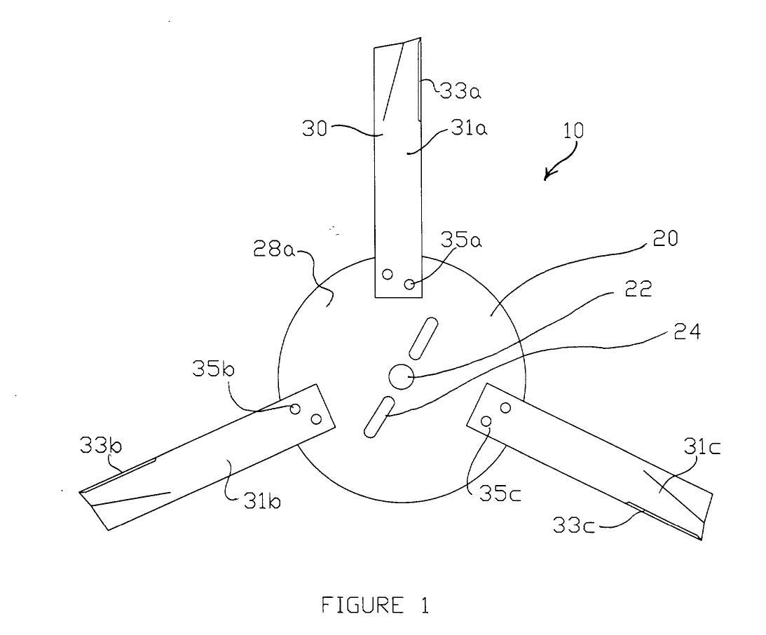

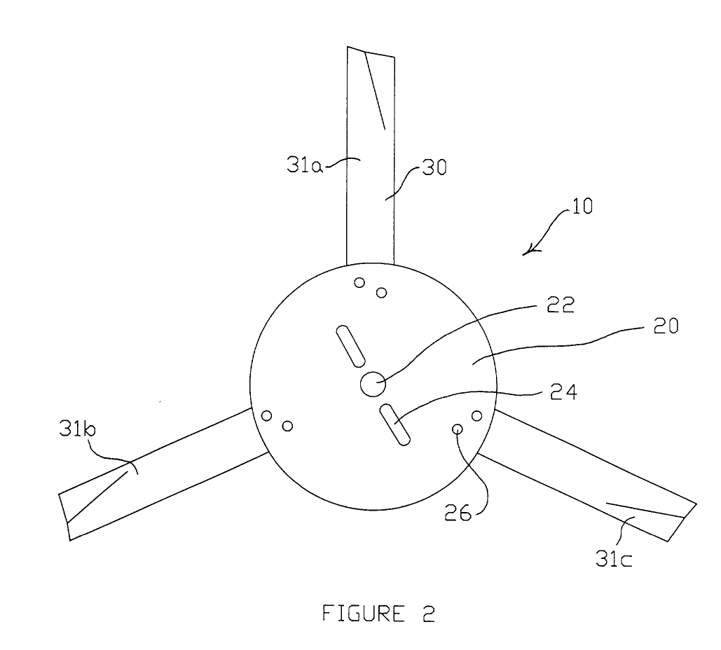

Referring now to FIGS. 1-2, the present invention is a lawn mower blade device 10, preferably having generally circular-shaped hub 20 with a plurality of cutting blades 30 removably mounted thereto. In the preferred embodiment, hub 20 is substantially flat and is adapted to be received on any conventional lawn mower, wherein centrally defined aperture 22 is universally adaptable to virtually any standard lawn mower drive shaft via adaptor bushings as known within the art, and wherein the adaptor bushings correspond to a particular size and/or brand specification for attachment to a mower drive shaft.

Preferably, a plurality of elongated apertures 24 are defined proximate to and generally surrounding centrally defined aperture 22, wherein each aperture of the plurality of elongated apertures 24 is dimensioned to receive at least one hub mounting member 40 (not shown) therethrough for secure attachment of hub 20 to a mower. The preferred elongated shape of apertures 24 enable adaptable placement and user-selected positioning of each hub mounting member 40, thereby corresponding to mounting receptacle positions on available lawn mowers to enable retrofit. Preferably, two elongated apertures 24 are provided, wherein each elongated aperture 24 is opposingly positioned relative to centrally defined aperture 22 to correspond to commonly known dual mounting receptacle arrangement. One skilled in the art would readily recognize that more than two elongated apertures 24 could be provided given the generally circular-shape of hub 20, wherein adaptation to and accommodation of any arrangement of mower mount receptacles would be enabled. Additionally, elongated apertures 24 could have any defined shape, wherein the generally circular shape of hub 20 enables inclusion of virtually any shape or size aperture and whereby accommodation of any type of mower mount receptacle could be enabled.

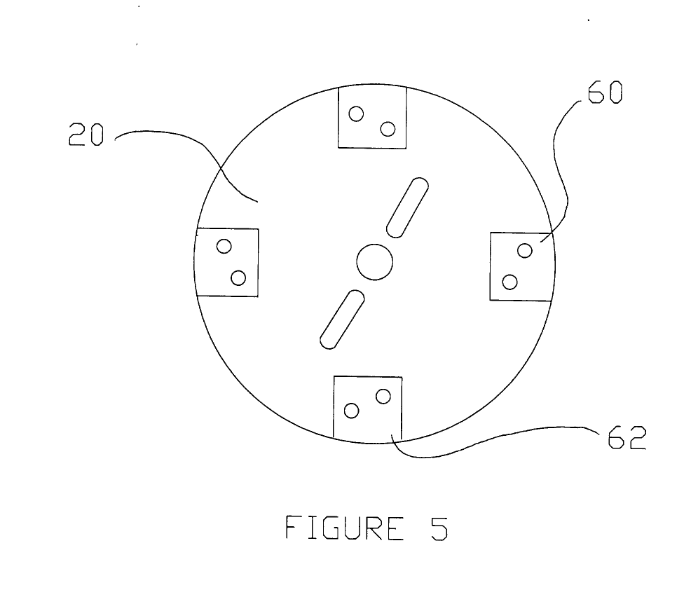

In the preferred embodiment, the plurality of cutting blades 30 includes three cutting blades 31a, 31b and 31c, with each blade 31a, 31b and 31c preferably removably secured to hub 20 in an arrangement wherein each cutting blade 31a, 31b and 31c extends outwardly from hub 20 to enable cutting surfaces 33a, 33b and 33c, respectively, thereof to contact the grass or vegetation during rotation of hub 20. While it is preferred that plurality of cutting blades 30 includes three blades 31a, 31b and 31c, it is contemplated and anticipated that alternate embodiments could include four or more blades, as depicted to be received by alternate hub in FIG. 5, without departing from the intended scope of the invention described herein. Also, it is contemplated that the plurality of cutting blades 30 could be integrally formed with hub 20.

Each blade 31a, 31b and 31c preferably possesses at least one blade mounting aperture 35a, 35b and 35c defined therethrough, and hub 20 has a plurality of corresponding blade mount receptacles 26, whereby blades 31a, 31b and 31c are removably secured to hub 20. It is recognized that more than one mounting aperture 35a, 35b and 35c could be provided for each blade 31a, 31b and 31c, respectively, wherein an equal number of corresponding mount receptacles 26 could be provided in hub 20.

Preferably, a plurality of blade mounting members 50 (not shown) are utilized to secure the plurality of cutting blades 30 to hub 20, wherein each of said plurality of blade mounting members 50 preferably is positioned through a blade mounting aperture 35a, 35b and 35c and into one of the plurality of blade mount receptacles 26. In the preferred embodiment, the plurality of blade mounting members 50 are aircraft locking bolts 52 (not shown). One skilled in the art would readily recognize that other types of blade mounting members could be utilized without departing from the intended scope of the invention as described herein, including but not limited to, spring-loaded or otherwise forcibly retained hardware enabling a quick-connect adaptation of cutting blades 30 to hub 20 for ease of replacement thereof.

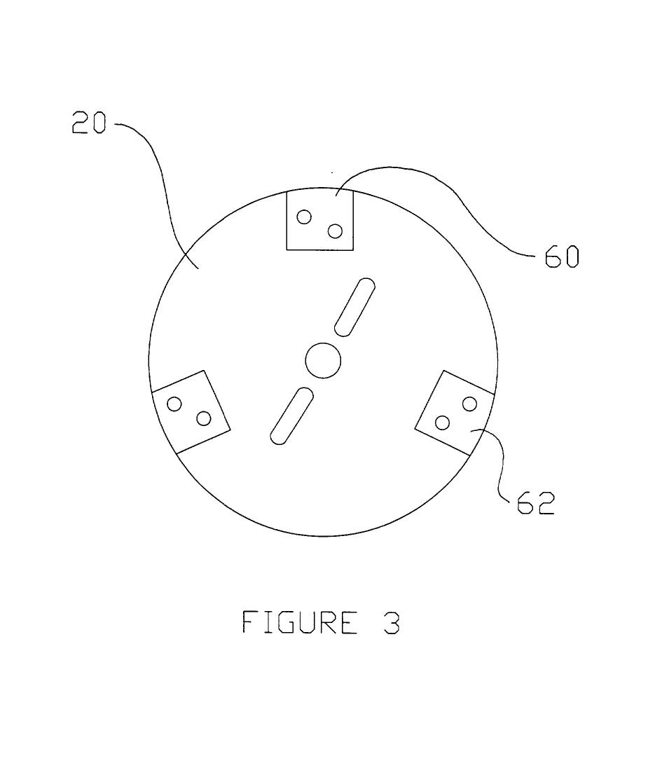

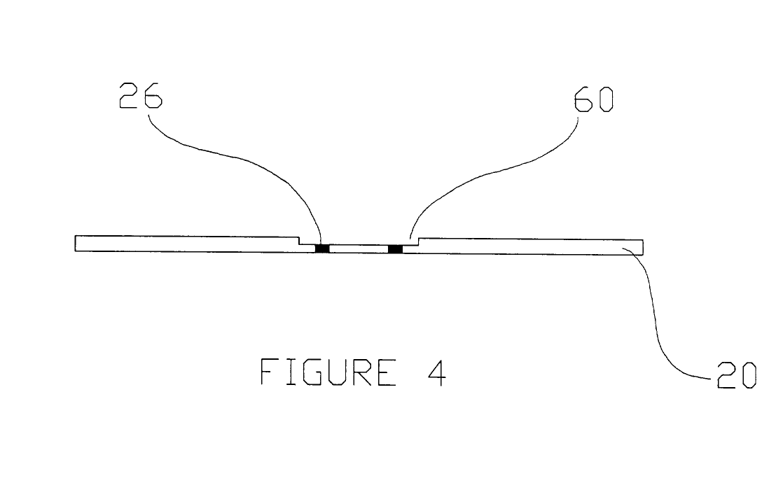

In an alternate embodiment best illustrated in FIGS. 3-4, first surface 28a of hub 20 could possess a plurality of recessed blade receiving areas 60 defined therein. Plurality of recessed blade receiving areas 60 enables generally flush positioning of plurality of cutting blades 30 relative to first surface 28a of hub 28a. Plurality of peripheral walls 62 of plurality of recessed blade receiving areas 60 provide additional support for each cutting blade 31a, 31b and 31c, thereby decreasing forces thereon during rotation of the motor shaft and reducing potential strain on plurality of blade mounting members 50. It is anticipated that any number of recessed blade receiving areas 60 could be defined on hub 20, wherein any number cutting blades could be secured thereto. Moreover, the defined peripheral shape of the plurality of recessed blade receiving areas 60 could be any shape suitable for receiving an end 36 of a cutting blade 31a, 31b, 31c.

In another alternate embodiment, a plurality of removable plates 62 could be provided, wherein each removable plate 62 could be dimensioned to fit substantially flush within the plurality of recessed blade receiving areas 60.

In another alternate embodiment, centrally defined aperture 22 and/or plurality of elongated apertures 24 of hub 20 could have any shape, size and/or relative position to enable accommodation of any particular motor mount design.

In another alternate embodiment, more than two elongated apertures 24 could be provided in hub 20, wherein adaptation to and accommodation of any arrangement of mower mount receptacles could be enabled.

In another alternate embodiment, each of the plurality of cutting blades 30 could incorporate removable and/or replaceable cutting edges and/or blade faces.

In another alternate embodiment, each of the plurality of cutting blades 30 could be removably secured to hub 20 via a plurality of fasteners thereby enabling a quick-disconnect feature, wherein spring-loaded nuts or any other appropriate hardware could be utilized to secure bolts or any other appropriate type of fasteners through the plurality of cutting blades 30 and into hub 20 to assist with user placement and removal of the plurality of cutting blades 30 without compromising security of blade positioning during use of lawn mower blade device 10.

In another alternate embodiment, lawn mower blade device 10 could be formed with more than three blades, as best illustrated in FIG. 5, wherein device 10 could utilize four blades, five blades, or any number of blades suitably sized and weighted for accommodation with a typical mower housing and for utilization with a typical mower motor.

In another alternate embodiment, each blade 31a, 31b and 31c of plurality of blades 30 could have more than two blade mounting apertures 35a, 35b and 35c, respectively, defined therethrough and hub 20 could have an equal plurality of corresponding blade mount receptacles.

In another alternate embodiment, plurality of blade mounting members 50 could be replaced and/or supplemented with welded and/or otherwise essentially permanent mounting arrangements to secure the plurality of cutting blades 30 to hub 20.

In another alternate embodiment, plurality of blade mounting members 50 could be eliminated and the plurality of cutting blades 30 could be integrally formed with hub 20.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A lawn mower blade device, comprising:
a generally circular-shaped hub having at least one means for mounting said hub to a lawn mower motor; and
at least three cutting blades carried by and radially extending from said hub, wherein each cutting blade of said at least three cutting blades has at least one cutting surface.

2. The lawn mower blade device of claim 1, wherein said at least three cutting blades are integrally formed with said generally circular-shaped hub.

3. The lawn mower blade device of claim 1, wherein each cutting blade of said at least three cutting blades is removably carried by said generally circular-shaped hub.

4. The lawn mower blade device of claim 3, wherein each cutting blade of said at least three cutting blades has at least one mounting aperture defined therethrough and wherein a fastener extends through said at least one mounting aperture of said cutting blade into said generally circular-shaped hub.

5. The lawn mower blade device of claim 1, wherein said lawn mower blade device is manufactured from metal.

6. The lawn mower blade device of claim 1, wherein each cutting blade of said at least three cutting blades has at least one removable blade face.

7. The lawn mower blade device of claim 1, wherein said means for mounting said hub to a lawn mower is a centrally defined, generally circular-shaped aperture, a plurality of elongated apertures defined proximate to said centrally defined aperture, and a plurality of bolt and nut members.

8. The lawn mower blade device of claim 7, further comprising adaptor bushings for said centrally defined, generally circular-shaped aperture.

9. The lawn mower blade device of claim 1, wherein said means for mounting said hub to a lawn mower is a plurality of apertures, wherein one aperture of said plurality of apertures is defined through the center of said hub, and a plurality of fasteners dimensioned to pass through said plurality of apertures in said hub.

10. The lawn mower blade device of claim 1, wherein said at least three cutting blades are carried by said hub via a plurality of locking bolts.

11. The lawn mower blade device of claim 10, wherein said plurality of locking bolts is a plurality of spring-loaded, quick-disconnect fasteners.

12. The lawn mower blade device of claim 1, wherein a first surface of said hub has a plurality of generally recessed blade receiving areas defined therein.

13. The lawn mower blade device of claim 1, wherein at least one of said at least three cutting blades is a mulching blade.

14. A lawn mower device, comprising:
a motor;
a housing for said motor;
a generally circular-shaped central blade support member rotationally carried by said motor; and
a plurality of generally rectangular-shaped, steel blades securely carried by said central blade support member, wherein each said steel blade has at least one sharpened edge.

15. The lawn mower device of claim 14, wherein said plurality of generally rectangular-shaped, steel blades are carried generally flush relative to an outer surface of said central blade support member, and wherein said central blade support member has a plurality of blade receiving ports defined therein.

16. The lawn mower device of claim 15, further comprising a plurality of coverplates for removably covering said blade receiving ports.

17. A lawn mower blade device, comprising:
a generally circular-shaped, substantially flat hub adapted to be received on any lawn mower; and
a plurality of cutting blades removably mounted to said generally circular-shaped hub and extending outwardly therefrom, wherein each said cutting blade of said plurality of cutting blades has a plurality of mounting apertures defined therethrough, and wherein a plurality of aircraft-type locking bolts extend through said plurality of mounting apertures of said cutting blades and said hub, securing said cutting blades to said hub.

18. A method of increasing lawn mowing efficiency, comprising the steps of:
a) increasing the effective cutting surface area of a lawn mower while maintaining mower housing size and cutting blade weight;
b) producing a more efficient and refined cut;
c) producing a cleaner, more refined grass clipping byproduct;
d) enabling maximized bag filling;
e) reducing bag-emptying frequency;
f) decreasing incidence of mower exit chute clogging;
g) reducing mower engine strain due to speed variation in response to grass density; and
h) extending mower lifespan.
